(19) United States
(12) Patent Application Publication
(10) Pub. No.: US 2020/0210883 A1
(43) Pub. Date: Jul. 2, 2020

(54) ACCELERATION OF MACHINE LEARNING FUNCTIONS

(71) Applicants: Awny Al-Omari, Cedar Park, TX (US); Choudur K. Lakshminarayan, Austin, TX (US); Yu-Chen Tuan, Dayton, OH (US)

(72) Inventors: Awny Al-Omari, Cedar Park, TX (US); Choudur K. Lakshminarayan, Austin, TX (US); Yu-Chen Tuan, Dayton, OH (US)

(21) Appl. No.: 16/235,611

(22) Filed: Dec. 28, 2018

(51) Int. Cl. G06N 20/00; G06F 16/2455; G06F 16/2453

(52) U.S. Cl. CPC G06N 20/00; G06F 16/24542; G06F 16/2455

(57) ABSTRACT

A multi-staged sample and seed machine-learning training technique is presented. A sample proportion of a training data set is fed to a machine-learning algorithm (MLA) for purposes of configuring functions of the MLA to predict an output with a desired degree of accuracy. When iterating the sample proportion, if a deviation in an incrementally produced current accuracy of the MLA does not exceed a threshold, the sampled proportion is increased. This continues until the current degree of accuracy meets or exceeds the desired degree of accuracy, which is an indication that the functions of the MLA are configured as a desired model for producing the predicted output when the MLA is presented with input that may or may not have been associated with the training data set.

### BACKGROUND

Generally, a machine-learning algorithm is serially trained on a voluminous set of training input data and corresponding known results for the input data until a desired level of accuracy is obtained for the machine-learning algorithm to properly predict a correct answer on previously unprocessed input data. Alternatively, a voluminous set of training input data is sampled, the sampled input data is used to serially train the machine-learning algorithm on a smaller set of input data.

During training, the machine-learning algorithm uses a variety of mathematical functions that attempt to identify correlations between and patterns within the training data and the known results. These attributes and patterns may be weighted in different manners and plugged into the mathematical functions to provide the known results expected as output from the machine-learning algorithm. Once fully trained, the machine-learning algorithm has derived a mathematical model that allows unprocessed input data to be provided as input to the model and a predicted result is provided as output.

A machine-learning algorithm can be trained to derive a model for purposes of predicting results associated a wide variety of applications that span the spectrum of industries.

One problem with machine-learning algorithm is the amount of elapsed time that it takes to train the machine-learning algorithm to derive an acceptable model when using a complete training data set. The input sampling approach is more time efficient in deriving a model, but the model is likely not tuned well enough to account for many data attributes and data patterns of the enterprise's data, which are viewed as important by the enterprise in predicting an accurate result.

Thus, the input sampling approach may produce a less accurate or even incorrect model while the full dataset training approach is too time and resource expensive.

### SUMMARY

In various embodiments, a system, methods, and a system for accelerating machine learning functions are provided.

In one embodiment, a method for accelerating machine learning functions is provided. A first sample data having a first size is obtained from a training data set for a machine-learning algorithm at a start of a training session for the machine-learning algorithm. The first sample data is provided to the machine-learning algorithm and accuracies in predicting known outputs produced by the machine-learning algorithm are noted. When a determination is made that a difference in a most-recent pair of accuracies fails to increase by a threshold, a next sample data having a second size that is larger than the first size is acquired and the processing associated with providing the first sample data is iterated back to with the next sample data. Finally, the training session is terminated and a model configuration for the machine-learning algorithm produced when a current accuracy meets a desired accuracy, determined based on a predetermined convergence criterion or threshold.

### BRIEF DESCRIPTION OF THE DRAWINGS

FIG. 1A is a diagram of a system for accelerating machine learning functions, according to an embodiment.

FIG. 1B is a diagram illustrating acceleration of machine learning functions, according to an example embodiment.

FIG. 1C is a diagram illustrating multi-stage acceleration of machine learning functions, according to an example embodiment.

FIG. 1D is a table illustrating performance advantages of the technique for accelerating machine learning functions, according to an embodiment.

FIG. 2 is a diagram of a method for accelerating machine learning functions, according to an example embodiment.

FIG. 3 is a diagram of another method for accelerating machine learning functions, according to an example embodiment.

FIG. 4 is a diagram of a system for accelerating machine learning functions, according to an example embodiment.

### DETAILED DESCRIPTION

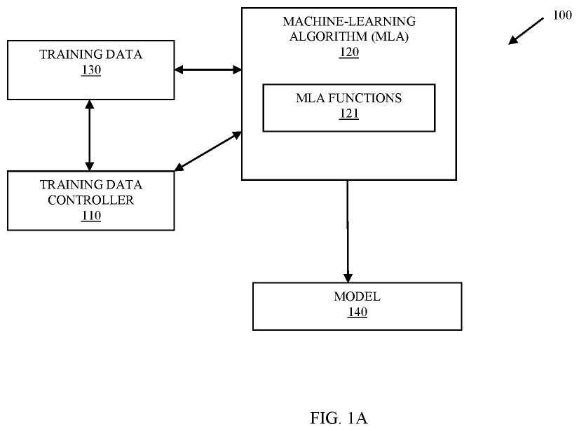

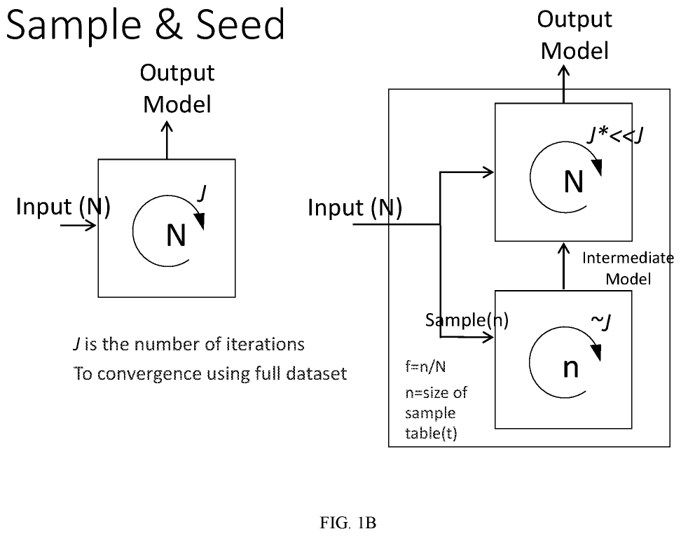

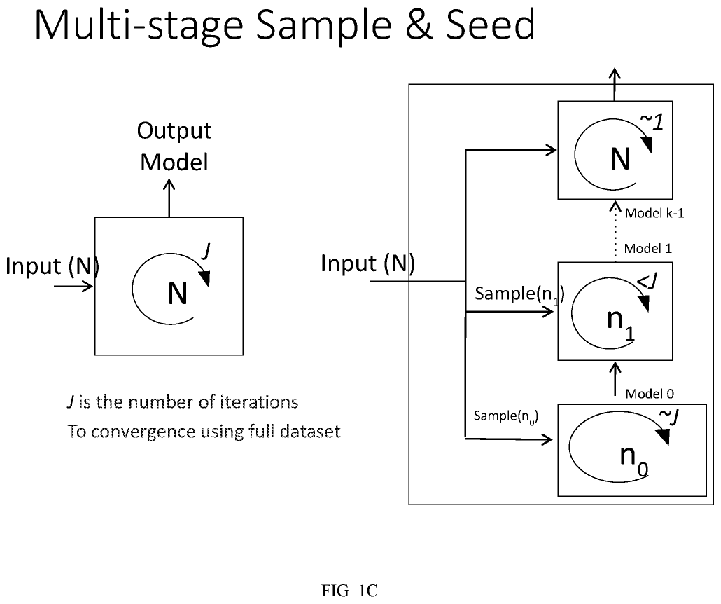

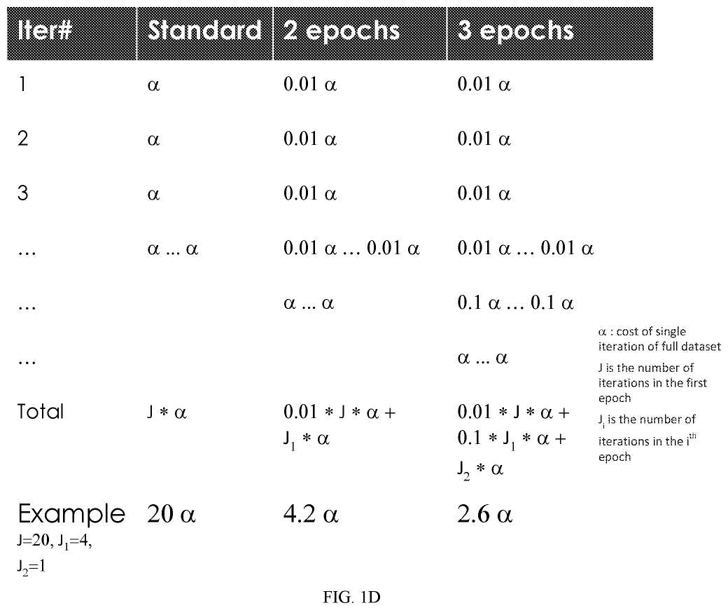

FIG. 1A is a diagram of a system 100 for accelerating machine learning functions, according to an embodiment. The system 100 is shown in greatly simplified form with just those components necessary for understanding the teachings of acceleration of machine learning functions illustrated. It is to be noted that a variety of other components or less components can be employed without departing for the teachings of acceleration of machine learning functions for a machine learning algorithm presented herein and below.

As will be more completely discussed herein and below, the teachings provided solves the industry debate and problem associated with whether a machine-learning algorithm is best trained utilizing a full training set of data or a sampling of a full training set of data. The techniques herein provides a best of both worlds solution by taking advantages of the fast convergence of the sampling approach while guaranteeing the correctness of the full data set approach. The approach provided seamlessly utilizes smaller samples to move faster to the neighborhood of model solution and uses larger samples, or full data set, to converge and seal a final accurate model. In an embodiment, the techniques are implemented using a Generalized Linear Model (GLM) regression and K-Means clustering functions.

The system 100 includes: a training data controller 110, a machine-learning algorithm (MLA) 120 having MLA functions 121, training data (training data set(s)) 130, and a final model 140 representing a full-trained configuration of the MLA 120 and the functions 140 for producing predicted outputs on new and previously unprocessed input data (which may or may not have been part of the training data set 130).

It is to be noted that the desired problem being addressed with the MLA 120 and the Model 140 can be any situation in which a ML solution is desired from an enterprise. This can range for image recognition and tracking to decisions as to whether fraud is present in a transaction. In fact, any problem for which there is input data and a desired classification or output decision on that input data can be used.

The system 100 permits the desired model 140 configuration for the MLA 120 and its functions 121 to be efficiently and quickly trained to produce an accuracy in predicting results equivalent to a MLA 120 trained on full data set of training data and known results.

The components 110, 120, 121, and 140 are implemented as executable instructions that reside in a non-transitory computer-readable storage medium. The executable instructions are executed from the non-transitory computer-readable storage medium on one or more hardware processors of a computing device.

The training data 130 can be provided from memory, non-transitory storage, or a combination of both memory and non-transitory storage.

In an embodiment, the training data 130 is provided from a database. As used herein, the terms and phrases “database,” and “data warehouse” may be used interchangeably and synonymously. That is, a data warehouse may be viewed as a collection of databases or a collection of data from diverse and different data sources that provides a centralized access and federated view of the data from the different data sources through the data warehouse (may be referred to as just “warehouse”).

The training data controller 110 is configured when executed to control the training data 130 that is iteratively provided to the MLA 120 during a training of the MLA to derive the model 140 (configuration of the MLA 120 and the functions 121).

The training data controller 110 samples the training data 120 in various sampling proportions and evaluates the accuracy of the underlying and current model configuration for the MLA functions 121 at each sampled proportion. Accuracy depends on sampling fraction, the number of iterations, desired accuracy, and number of different types of data provided in the sampled data (such as columns in a database that identify data types).

For purposes of illustration herein, the training data 120 is a database having tables, each table having columns representing the fields or data types in a table, and each table includes rows that span the columns.

The training data controller 110 sets N as the total numbers of rows in the training dataset 120. The training data controller 110 then sets the initial training size provided to the MLA 130 as n0 (which can be heuristically selected based on current available memory allocation for an initial epoch and the size of the total dataset 120). For example, the training data controller 110 heuristically determines n0 as max(M/R, f*N), where M is a constant representing memory allowed (for example 100 MB), R is the recorded size, and f is the sampling proportion of the overall dataset 120 (for example 0.01).

The training data controller 110 determines the sample sizes that follow (n1, n2, . . . , N) based on exponentially increasing the sample size in each epoch (i.e., sample fraction). The sample size in epoch k is given by: nk=n0Z^{k}, where Z is the exponent of a given base, such as 2 or 10.

The training data controller 110 iterates over each epoch feeding the data from the samples to the MLA 130 and checking the accuracy produced from the functions 121 that are being configured until a stopping criterion is met to transition to the next sampling size epoch. If the transition (stopping) criterion is met, the sample size is increased for the next epoch.

The transaction criterion is designed based on the principal of diminishing returns. The convergence rate within an epoch is compared with expected deviation in the Root Mean Square Error (RMSE) of the model results in the current epoch. This implies that the system 100 resources are invested in the epoch with the highest return being available for producing model accuracy. So, the transaction criterion can be set and measured by the training data controller 110 within the current epoch to determine when the return (increase in accuracy) produced in results in the current configuration of the functions 121 reach a point that continuing with data sampling associated with the epoch is not worth the investment and providing an indicating to the training data controller 110 is to move to a larger sampling of the dataset 130 in a next epoch. Each next epoch includes an exponential increase in the data sampling size (as discussed above).

The training data controller 110 essential samples the data set 130 and seeds the MLA 120 with that sample multiple times, as soon as it becomes apparent that the accuracy or current configuration for the model is not producing an increase in accuracy that is acceptable (based on the transition criterion), the sample size is exponentially increased and fed to the MLA 120. This approach allows for a faster and more resource (hardware and software) efficient derivation of a final model 140 that is of the desired accuracy while ensuring that a robust enough (with variations in the data of the data set 130) of the full dataset 130 was accounted for and processed by functions 121. It achieves the accuracy in the final mode 140 of the full-complete data set training approach while utilizing a novel variation of the faster sampling training approach.

Conventional MLA require training and iterations over large datasets, each iteration can be taxing on processors and memory while the machine learning functions process. The industry has either stayed with this expensive approach utilizing a full training data set approach or has utilized a much smaller training data set in a sampling training approach. The sampling training approach may partially solve the issue of taxing the hardware resources, but is not robust enough and results in an inferior model for the functions of the MLA having less accuracy than is often desired.

The present approach solves both the taxing of the hardware issues and the accuracy of the model 140 issue while obtaining the model 140 much faster and utilizing less hardware resources than can be achieved with the full data set training approach and the sampling data training approach.

The training data controller 110 uses sampled and controlled proportions of the data set 130 until a first convergence is detected, such that there is no beneficial degree in the change in accuracy in the model being configured in the functions 121 in continuing with the current sampled data proportion. The proportion in the sample size is then exponentially increased and iteratively continues until the desired accuracy for the model 140 is achieved. This is entirely transparent to the user training the MLA 120. This results in fast convergence on the final model 140 configuration of the functions 121 for the MLA 120 with the desired accuracy as if the full dataset training approach was used.

The FIG. 1B illustrates a sample proportion of the data N being inputted in the MLA 120 and processed by the functions 121 to configure the functions 121 as an initial model. This is a sample and seed approach, as discussed above. The FIG. 1B illustrates a 2 stage sample and seed with a first sample proportion used and then a final full data set 130 used to arrive at the final model 140.

The FIG. 1C illustrates that a multi-stage sample (k stages) and seed approach can be used as discussed above, with multiple epochs each with a larger (exponentially larger) sampled proportion of the data set 130.

The FIG. 1D illustrates the performance advantages determined during testing achieved with a two-stage seed and sample approach of the FIG. 1B and a multi-stage seed and sample approach of the FIG. 1C versus a complete data set training approach. In the testing a GLM model was used for the MLA 120. The data set 130 comprised 100 million rows of data with 101 columns having a total of 100 data attributes. The standard complete data set training resulted in 823 seconds of processor elapsed processing time and required 63 iterations on the full data set 130. The multi-stage sample and seed approach results in 37 seconds of processor elapsed time with just one complete iteration of the full data set 130 (some of which were multiple iterations on sub-samples within a sampled data proportion).

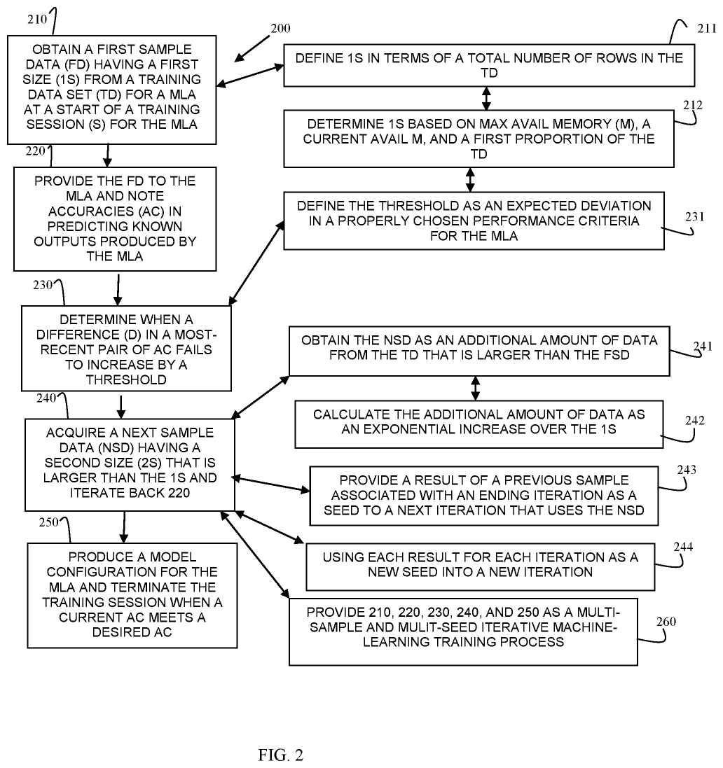

FIG. 2 is a diagram of a method 200 for accelerating machine learning functions, according to an example embodiment. The method 200 is implemented as one or more software modules referred to as a “MLA trainer”). The MLA trainer represents executable instructions that are programmed within memory or a non-transitory computer-readable medium and executed by one or more hardware processors of a device. The MLA trainer may have access to one or more network connections during processing, which can be wired, wireless, or a combination of wired and wireless.

In an embodiment, the MLA trainer is implemented within a data warehouse across one or more physical devices or nodes (computing devices) for execution over a network connection.

In an embodiment, the MLA trainer is the training data controller 110.

At 210, the MLA trainer obtains a first sample of data having a first size from a training data set for a MLA at a start of a training session for the MLA.

In an embodiment, at 211, the MLA trainer defines the first size of data in terms of a total number of rows in the training data set.

In an embodiment of 211 and at 212, the MLA trainer determines the first size based on a maximum available memory for the device that executes the MLA, a currently unused and available amount of memory, and a first proportion of the training data set.

At 220, the MLA trainer provides the first sample of data to the MLA and notes accuracies in predicting known outputs that are being produced by the MLA.

At 230, the MLA trainer determines when a difference in a most-recent pair of accuracies fails to increase by a threshold.

In an embodiment of 212 and 230, at 231, the MLA trainer defines the threshold as properly chosen performance criteria (such as a RMSE) for the MLA.

At 240, the MLA trainer acquires a next sample of data from the training data set having a second size that is larger than the first size and iterates back to 220 with a larger amount of training data for training the MLA.

In an embodiment, at 241, the MLA trainer obtains the next sample as an additional amount of data from the training data set that is larger than the first sample of data.

In an embodiment of 241 and at 242, the MLA trainer calculates the additional amount of data as an exponential increase over the first size of the first sampled data.

In an embodiment, at 243, the MLA trainer provides a result of a previous sample associated with an ending iteration as a seed to a next iteration that uses the next sample data.

In an embodiment, at 244, the MLA trainer uses each result for each iteration as a new seed into a new iteration.

At 250, the MLA trainer produces a model configuration for the MLA and terminates the training session when a current accuracy for the MLA meets a desired or expected accuracy for the MLA.

In an embodiment, at 260, the processing at 210, 220, 230, 240, and 250 of the MLA trainer is provided as a multi-sample and multi-seed iterative machine-learning training process.

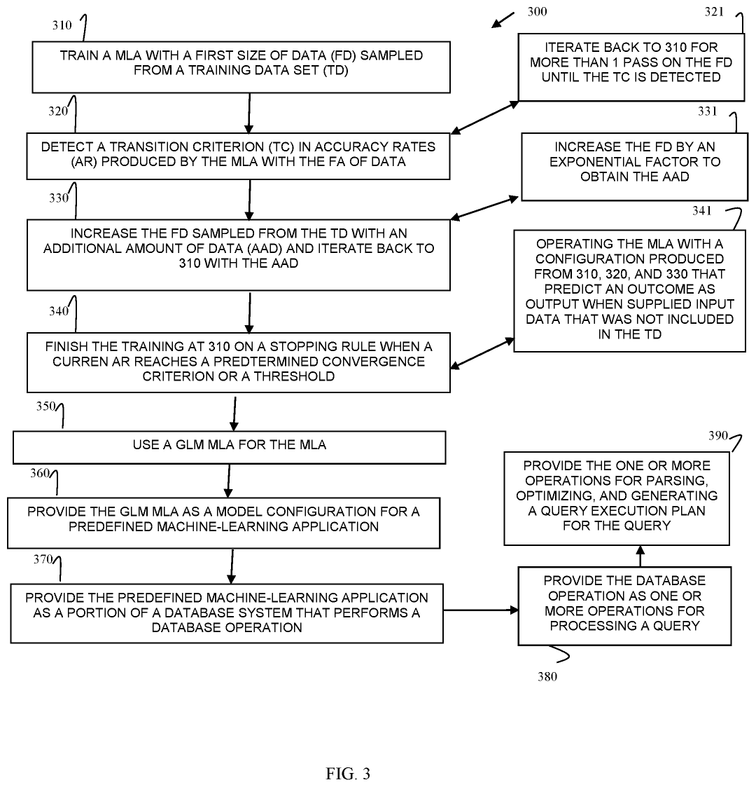

FIG. 3 is a diagram of another method 300 for MLA trainer, according to an embodiment. The method 300 is implemented as one or more software modules referred to as a “MLA training manager.” The MLA training manager represents executable instructions that are programmed within memory or a non-transitory computer-readable medium and executed by one or more hardware processors of a device. The MLA training manager may have access to one or more network connections during processing, which can be wired, wireless, or a combination of wired and wireless.

The MLA training manager presents another and in some ways enhanced perspective of the processing discussed above with the FIGS. 1A-1D and 2.

In an embodiment, the MLA training manager is all or any combination of: the training data controller and/or the method 200.

At 310, the MLA training manager trains a MLA with a first size of data sampled from a training data set.

At 320, the MLA training manager detects transition criterion in accuracy rates produced by the MLA with the first size of data.

In an embodiment, at 321, the MLA training manager iterates back to 310 for more than 1 pass on or over the first size of data until the transition criterion is detected.

At 330, the MLA training manager increases the first data sampled from the training data set with an additional amount of data and iterates back to 310.

In an embodiment, at 331, the MLA training manager increases the first data of the first size by an exponential factor to obtain the additional amount of data.

At 340, the MLA training manager finishes the training, at 310, on a stopping rule when a current accuracy rate reaches a predetermined convergence criterion or threshold.

In an embodiment, at 341, the MLA training manager operates the MLA with a configuration produced from 310, 320, and 330 that predicts an outcome as output when supplied input data that was not included in the training data set.

In an embodiment, at 350, the MLA training manager uses a GLM MLA for the MLA.

In an embodiment of 350 and at 360, the MLA training manager provides the GLM MLA as a model configuration for a predefined machine-learning application.

In an embodiment of 360 and at 370, the MLA training manager provides the predefined machine-learning application as a portion of a database system that performs a database operation.

In an embodiment of 370 and at 380, the MLA training manager provides the database operation as one or more operations for processing a query.

In an embodiment of 380 and at 390, the MLA training manager provides the one or more operations for parsing, generating, optimizing, and/or generating a query execution plan for the query.

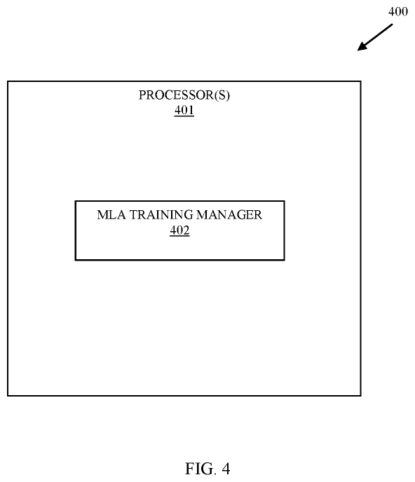

FIG. 4 is a diagram of a system 400 for MLA training manager, according to an example embodiment. The system 400 includes a variety of hardware components and software components. The software components are programmed as executable instructions into memory and/or a non-transitory computer-readable medium for execution on the hardware components (hardware processors). The system 400 includes one or more network connections; the networks can be wired, wireless, or a combination of wired and wireless.

The system 400 implements, inter alia, the processing discussed above with the FIGS. 1A-1D and 2-3.

The system 400 includes at least one hardware processor 401 and a non-transitory computer-readable storage medium having executable instructions representing a MLA training manager 402.

In an embodiment, the MLA training manager 402 is all of or any combination of: the training data controller 110, the method 200, and/or the method 300.

The MLA training manager 402 is configured to execute on the at least one hardware processor 401 from the non-transitory computer-readable storage medium to perform processing to i) obtain sampled data from a training data set; ii) iteratively supply the sampled data as training data to a machine-learning algorithm; iii) detect a transition criterion indicating that an accuracy of the machine-learning algorithm is marginally increasing with the sampled data; and iv) add an additional amount of data from the training data set to the sampled data and repeat ii) and iii) until a current accuracy for the machine-learning algorithm meets an expected accuracy.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method, comprising:
obtaining a first sample data having a first size from a training data set for a machine-learning algorithm at a start of a training session for the machine-learning algorithm;
providing the first sample data to the machine-learning algorithm and noting accuracies in predicting known outputs produced by the machine-learning algorithm;
determining when a difference in a most-recent pair of accuracies fails to increase by a threshold;
acquiring a next sample data having a second size that is larger than the first size and iterating back to the providing with the next sample data of a larger size; and
producing a model configuration for the machine-learning algorithm and terminating the training session when a current accuracy meets a desired accuracy.

2. The method of claim 1, wherein obtaining further includes defining the first size in terms of a total number of rows in the training data set.

3. The method of claim 2, wherein obtaining further includes determining the first size based on a maximum available memory, a current available memory, and a first proportion of the training data set.

4. The method of claim 3, wherein determining further includes defining the threshold as an expected deviation in properly chosen performance criteria for the machine-learning algorithm.

5. The method of claim 1, wherein acquiring further includes obtaining the next sample of data as an additional amount of data from the training data set that is larger than the first sample of data.

6. The method of claim 5, wherein obtaining further includes calculating the additional amount of data as an exponential increase over the first size.

7. The method of claim 1, wherein acquiring further includes providing a result of a previous sample associated with an ending iteration as a seed to a next iteration that uses the next sample data.

8. The method of claim 1, wherein acquiring further includes using each result for each iteration as a new seed into a new iteration.

9. The method of claim 1 further comprising, providing the obtaining, the providing, the determining, the acquiring, and the producing as a multi-sample and multi-seed iterative machine-learning training process.

10. A method comprising:
training a machine-learning algorithm with a first size of data sampled from a training data set;
detecting a transition criterion in accuracy rates produced by the machine-learning algorithm with the first size of data;
increasing the first size of the data sampled from the training data set with an additional amount of data and iterate back to the training with the additional amount of data;
finishing the training on a stopping rule when a current accuracy rate reaches a predetermined convergence criteria or threshold.

11. The method of claim 10 further comprising:
using a Generalized Linear Model (GLM) machine-learning algorithm for the machine-learning algorithm.

12. The method of claim 11 further comprising:
providing the GLM machine-learning algorithm as a model configuration for a predefined machine-learning application.

13. The method of claim 12 further comprising:
providing the predefined machine-learning application as a portion of a database system that performs a database operation.

14. The method of claim 13 further comprising:
providing the database operation as one of more operations for processing a query within the database system.

15. The method of claim 14 further comprising:
providing the one or more operations for parsing, optimizing, and generating a query execution plan for the query.

16. The method of claim 10, wherein detecting further includes iterate back to the training for more than 1 pass over the first size of data sampled from the training data set until the transition criterion is detected.

17. The method of claim 10, wherein increasing further includes increasing the first size of the data by an exponential factor to obtain the additional amount of data.

18. The method of claim 12, wherein finishing further includes operating the machine-learning algorithm with a configuration of machine-learning functions of the machine-learning algorithm produced from the training, the detecting, and the increasing that predict an outcome as output when supplied input data that was not included in the training data set.

19. A system, comprising:
at least one hardware processor;
a non-transitory computer-readable storage medium having executable instructions representing a machine-learning training manager;
the machine learning training manager configured to execute on the at least one hardware processor from the non-transitory computer-readable storage medium and to perform processing to:
i) obtain sampled data from a training data set;
ii) iteratively supply the sampled data as training data to a machine-learning algorithm;
iii) detect a transition criterion indicating that an accuracy of the machine-learning algorithm is marginally increasing with the sampled data; and
iv) add an additional amount of data from the training data set to the sampled data and repeat ii) and iii) until a current accuracy for the machine-learning algorithm meets an expected accuracy.

20. The system of claim 19, wherein the machine-learning algorithm is a Generalized Linear Model machine-learning algorithm.
